(19) United States
(12) Patent Application Publication
(10) Pub. No.: US 2017/0311584 A1
(43) Pub. Date: Nov. 2, 2017

(54) VIBRATING BIRD DETERRENT DEVICE

(71) Applicant: John E. Hudson, Gainesville, FL (US)

(72) Inventor: John E. Hudson, Gainesville, FL (US)

(21) Appl. No.: 15/641,281

(22) Filed: Jul. 4, 2017

Related U.S. Application Data
(63) Continuation-in-part of application No. 14/693,295, filed on Apr. 22, 2015.
(60) Provisional application No. 62/052,258, filed on Sep. 18, 2014.

(51) Int. Cl. A01M 29/22; A01M 29/16; A01K 39/01

(52) U.S. Cl. CPC A01M 29/22; A01K 39/0113; A01M 29/16

(57) ABSTRACT

A bird deterrent device is configured for use in common garden bird-feeders. A flexible vibrating tip is electrically connected to a power supply and a wireless receiver via electrical wiring. A remote transmitter is operable to send a signal to the wireless receiver. When the wireless receiver receives the signal, the vibrating tip produces a vibration to generate visual, auditory and structural vibrations in the associated feeder, thereby scaring away targeted undesirable birds.

### RELATED APPLICATION

This application is a continuation-in-part of pending U.S. application Ser. No. 14/693,295 filed on Apr. 22, 2015 which claims the benefit of priority of U.S. provisional application No. 62/052,258, filed Sep. 18, 2014, the contents of which are herein incorporated by reference.

### BACKGROUND OF THE INVENTION

The present invention relates to bird feeders and, more particularly, to bird deterrents that are attachable to various types and shapes of bird feeders. Bird feeders are devices placed outdoors to supply bird food to birds. Most bird feeders supply seeds or other forms of bird food. Bird feeders often are used for bird watching. Currently, bird feeders can attract all sorts of birds, even birds that may be undesirable to the bird feeder owner. For example, “bully” birds, such as crows and grackles, often dominate the bird feeders and prevent other birds from feeding. Some feeder owners want to feed only colorful song birds, and some want to restrict the type of bird even further. Current methods of deterring undesirable birds may include, screens that allow only small birds, electrically shocking the birds or producing noises simulating or mocking a predator. Many bird watchers consider electrically shocking a bird to be inhumane, and producing predator noises scares away other desirable birds and screens allow only small birds to feed and exclude all large birds. As can be seen, there is a need for an improved device for deterring certain birds from eating from a bird feeder.

### SUMMARY OF THE INVENTION

The present invention consists of an electrically powered device that produces multiple forms of sensory simulation that when perceived by birds produces a distracting or frightening sensory effect. The inventive device is physically configured to be located on or adjacent to or in sufficiently close proximity to a typical home bird feeding device so that the produced sensory simulation is perceived by a bird at the feeding device.

In particular embodiments of the invention, simulations are produced to be perceived by at least three different senses of a bird: visual, audible and tactile. It is necessary for the desired performance of the device to generate at least these three simulations simultaneously. Moreover the device must be sized and configured to operate within the physical limits of a typical home bird-feeder.

In one aspect of the present invention, a bird deterrent device comprises: a control unit comprising a housing, a wireless receiver within the housing, a power supply and a vibrating tip including a vibration driver that is electrically connected to the power supply and the wireless receiver via electrical wiring. A remote transmitter is operable to send a signal to the wireless receiver, wherein when the wireless receiver receives the signal, the vibrating tip produces a vibration. To enable three different simulations as desired, the tip is secured via a flexible wiring that allows for movement of the tip due to activation of the vibrating driver.

The invention includes methods of selectively deterring birds using the inventive device in conjunction with a convention bird feeding device.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention, shown in use.

FIG. 2 is a perspective view of an embodiment of the present invention FIG. 3 is a schematic view of an embodiment of the present invention.

FIG. 4 is a perspective view of the present invention illustrating the activation of the vibrating tip by the transmitter.

FIG. 5 is a detailed illustration of the vibration tip element of the invention.

FIG. 6 illustrates a preferred vibration tip according to the invention.

### DETAILED DESCRIPTION OF THE INVENTION

It is a critical element of the present invention that the bird deterrent device stimulate at least three (3) of their five (5) senses at once as birds learn that single stimulations such as vibration alone will not hurt them. Testing of the present invention has shown that birds do not accommodate to simultaneous stimulation of hearing, sight and tactile senses.

The present invention may include a battery or low voltage powered, radio frequency activated, low volume nonthreatening audible, physical movement, and vibration creating device that scares birds on bird feeders making them fly away. The present invention emits sounds that are quiet enough not to affect the entire area around or near the feeder. At the same time visual stimulation comes from movement of a physical object near the bird. The vibration also causes tactile stimulation. That is the device includes a physical element configured to be placed adjacent a bird feeder structure such as to transmit vibration to the structure such as to be felt by any bird presently perched on the structure. The stimulation of a combined simultaneous stimulation of visual, audible and tactile senses caused by the device scares the undesirable bird away.

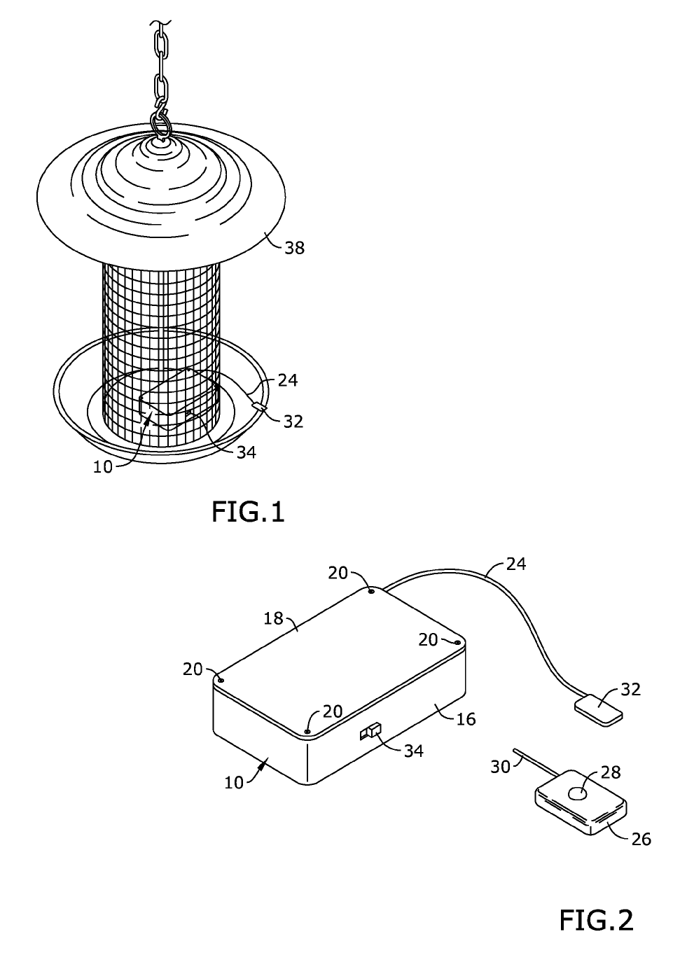

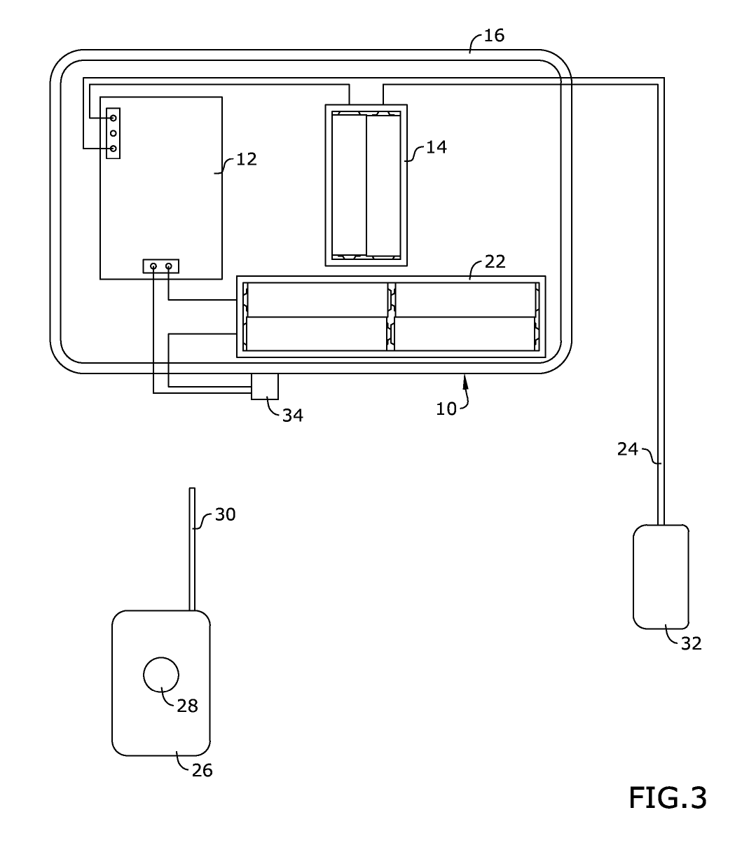

Referring to FIG. 1 through 4, the present invention includes a bird deterrent 10. The bird deterrent 10 includes a control unit 16. The control unit 16 includes a housing with to contain internal components. A wireless receiver 12 is secured within the control unit 16. The control unit further includes a power supply 14 to supply power to the vibration tip 32. The vibrating tip 32 is electrically connected to the power supply 14 and the wireless receiver 12 via electrical wiring 24. A remote transmitter 26 is operable to send a signal 40 to the wireless receiver 12. When the wireless receiver 12 receives the signal 40, the vibrating tip 32 produces a vibration.

The electrical wire 24 may include a first electrical wire connecting the power supply 14 to the vibrating tip 32, a second electrical wire connecting the vibrating tip 32 to the wireless receiver 12, and a third electrical wire connecting the power supply 14 and the wireless receiver 12. Therefore, when the remote transmitter 26 sends the signal 40, the second electrical wire and the third electrical wire may close the circuit from the power supply 14 to the vibrating tip 32, and thereby activating the vibrating tip 32. As mentioned above, the present invention includes a remote transmitter 26. The remote transmitter 26 may include an antenna 30 to aid in the wireless transfer of the signal 40 to the wireless receiver 12. In certain embodiments, the remote transmitter 26 may include a button 28. The user 36 may press the button 28 to activate the transmission of the signal 40 from the antenna 30 to the wireless receiver 12. The present invention may further include a switch 34 connected to the housing. The switch 34 may be electrically wired to a second power supply 22 for the wireless receiver 12. When placed in an on position, the switch 34 connects the second power supply 22 to the receiver 12 allowing electricity to flow to the receiver 12. When switch 34 is placed in an off position, the power flow is stopped preventing the receiver 12 from draining the second power supply 22 when the unit is not in use. A fourth wire may connect the switch 34 to the second power supply 22, a fifth wire may connect the second power supply 22 to the wireless receiver 12, and a sixth wire may connect the switch 34 to the wireless receiver 12. In certain embodiments, the present invention may include a single power supply 22 and 14 combined. This single power supply 22 and 14 combined may be used to power the wireless receiver 12 and the vibration tip 32.

In certain embodiments, both the power supply 14 and the second power supply 22 may be secured within the control unit 16. The power supply 14, 22 may include batteries. In such embodiments, the control unit 16 may include a removable lid 18. Therefore, a user may remove the lid 18 to replace the batteries. Other power supply configurations including rechargeable batteries may also be used.

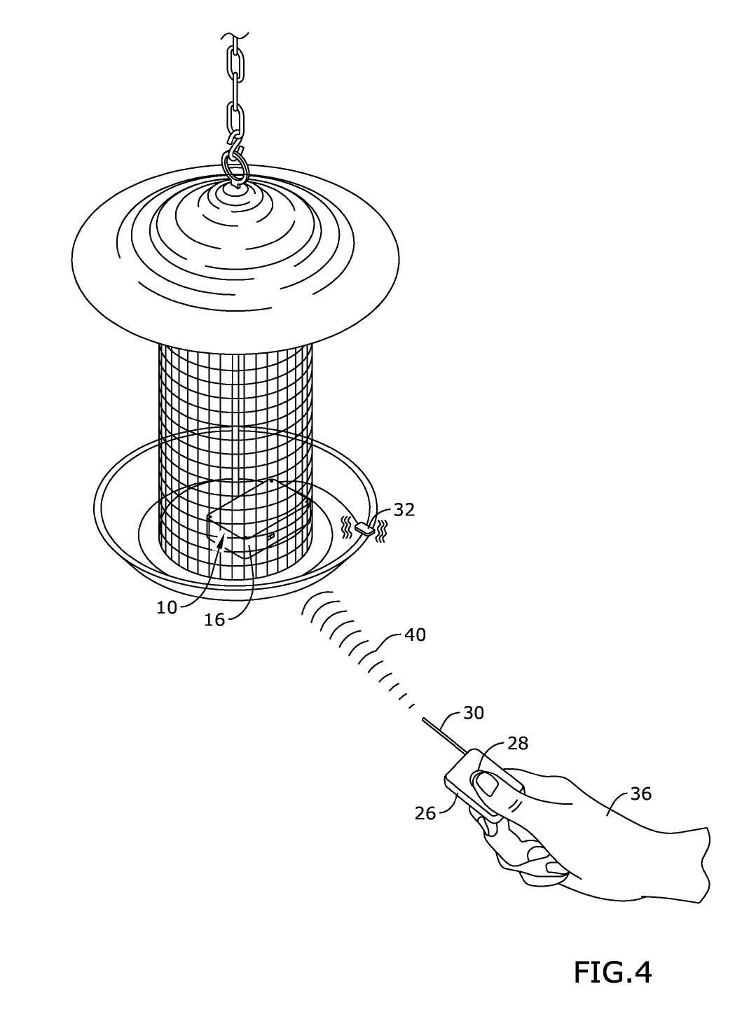

As illustrated in FIG. 4, the control unit 16 may be placed in one portion of the bird feeder, and the vibrating tip 32 may be placed adjacent or at a separated point of the bird feeder. For example, the vibration tip 32 may be dangling outside of the bird feeder where the bird sits. In operation, the user 36 sees an undesirable bird eating at the feeder. Upon activation by pressing the remote control transmitter 26, the vibration tip 32 begins to vibrate, making noise, motion, and vibration. Therefore, a quick press of the button 28 on the transmitter scares the undesirable bird away, then shuts off when the transmitter button 28 is released, allowing desirable birds to return.

A critical aspect of the invention is that the physical stimulations generated: noise, movement, vibration are configured to be perceived only in the proximity of the device—that is on or near the bird-feeder on which the device is placed. This is to limit the effect on the known undesirable birds that are at the moment located on the feeder. It is important that the stimulations are not generally perceivable from a greater distance—from distances greater than approximately 20 feet from the device. If the stimulations are perceivable beyond this range, the device and user will not be able to limit their effects to local undesirable birds.

To accomplish these effects, the device should first have a size sufficiently small to be located in or on a bird feeder. In generally, this means a maximum linear dimension of no more than about 6 to 7 inches although smaller sizes are greatly desireable. The extent of vibration, motion and noise is greatly linked to the size and frequency of the vibration driver in the tip 32.

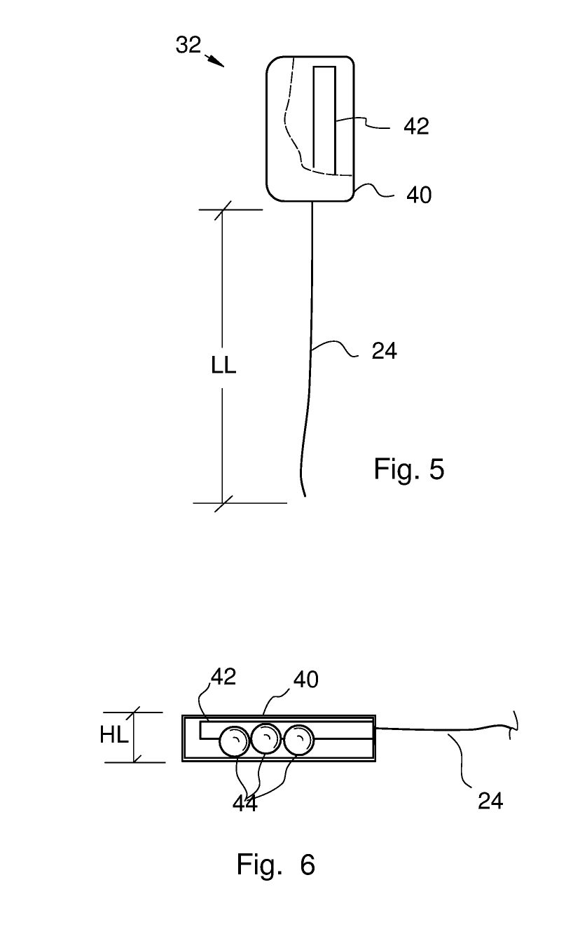

FIG. 5 is an enlarged view of the tip 32. The tip 32 includes a plastic or metal shell housing 40 in which a vibration driver 42 is contained. The housing 40 functions as environment protection for the vibration driver 42 and secondarily as a sounding “bell” against which the vibration driver 42 strikes during vibration to generate noise. For this purpose, the housing 40 should be not substantially heavier than the vibration driver 42. For this purpose also the vibration driver 42 should be mounted to allow relative motion between the vibration driver 42 (or some part thereof) and the housing 40.

A preferred vibration driver 42 has a small size and weight to enable appropriate movements and sound. An effective vibration driver 42 is provided by an eccentric rotating mass vibration motor, commonly in the motor industry referred to as a “pager” motor. An appropriate device is provided by Precision Microdrives Ltd of London, England under the model number 307-103. This device has a weight of about 5 grams and a length of about 25 millimeters and operates at a speed of about 13800 RPM (230 hz). When this device operates within a housing 40 of approximately the same size, housing lateral movements in a range of no more than a few millimeters (maximum of 5 millimeters) are produced and an audible but low vibration can be heard. Similar results may be possible with smaller devices, but substantially larger devices will result in either insufficient movement or excess sound. An upper weight limit for effective results is estimated at about 20 grams.

FIG. 6 illustrates a preferred vibration tip 32. In this embodiment, three steel balls 44 are contained, loosely, within the housing 40 with the vibration driver 42. Upon operation of the vibration driver 42, the resultant relative movement of the housing 40 and the balls 44 produce an effective vibration sound. The housing 40 is formed of a thin-walled steel case polished to a reflective finish and weighing no more than 0.5 ounce. Again, the size and weight of the housing and vibration tip 32 are limited to ensure producing effective stimulation. To produce the desired relative movement and sound, the balls 44 must have a size relatively smaller that the internal space of the housing. For example, a housing height dimension HL of about 9.5 millimeters together with balls having a diameter of 3.1 millimeters are effective. For the same purpose, it is preferred that the vibration driver 42 be unsecured within the housing 40. That is, the vibration driver 42 is without mounting but is free to move relative to the housing 40.

Movement of the combined vibration driver 42 and housing 40 is also dependent on the lack of restriction on the housing. As shown in the figures, the tip 32 is placed freely, without attachment, to a bird feeder. The only impediment to movement is the electrical wire 24 that extend from the control unit 16 to the tip 32. To ensure that the tip 32 has the desired free movement, the wire 24 must be substantially flexible with respect to the weight of the vibration driver 42. In a preferred device, the wire 24 is formed of a pair of 32 gauge multi-strand copper leads with plastic insulation. This may be covered with a protective sheath if such does not substantially increase the stiffness of the wire 24. Wire leads larger in diameter than 24 gauge is likely to not provide the needed flexibility.

Flexibility of the wire 24 is also dependent on the length dimension LL of the wire 24. The length dimension LL is the linear extent of the wire 24 between the control unit 16 and the tip 32. A length dimension LL in the range of 100 to 200 millimeters is suggested. A length dimension less then 25 millimeters will likely not provide sufficient movement of the tip 32 or to not be visible to the targeted birds.

In methods of the invention, the above control unit 16 is located within a bird feeder structure and the tip 32 located loosely placed on a horizontal surface of the bird feeder or placed hanging freely. When a user observes an undesirable bird on or near the bird feeder, the user operates the remote transmitter to cause the tip 32 to vibrate and scare the undesirable bird. Operation must be discontinued at that point.

The above detailed descriptions are of the best currently contemplated modes of carrying out exemplary embodiments of the invention. The description is not to be taken in a limiting sense, but is made merely for the purpose of illustrating the general principles of the invention, since the scope of the invention is best defined by the appended claims. It should be understood, of course, that the foregoing relates to particular embodiments of the invention and that modifications may be made without departing from the spirit and scope of the invention as set forth in the following claims.

I claim:

1. A bird deterrent device comprising:
a control unit including a power supply and wireless receiver;
a vibration tip;
a wire connecting the control unit and the vibration tip and configured to provide power to the vibration tip;
the vibration tip comprising a housing and a vibration driver contained in the housing, the vibration tip configured to produce movement, sound and vibration when provided with power;
the wire is sufficiently flexible to not impede movement of the vibration tip.

2. A bird deterrent device according to claim 1, and wherein:
the vibration driver is an electric motor having a weight less than 20 grams.

3. A bird deterrent device according to claim 2, and wherein:
the housing and vibration driver are configured to allow for relative movement between them within the housing.

4. A bird deterrent device according to claim 3, and wherein:
the wire has a length of at least 25 millimeters.

5. A bird deterrent device according to claim 3, and further comprising:
multiple balls disposed loosely within the housing.
